(19) United States
(12) Patent Application Publication
(10) Pub. No.: US 2018/0339262 A1
(43) Pub. Date: Nov. 29, 2018

(54) METHOD, DEVICES AND SYSTEMS FOR RADON REMOVAL FROM INDOOR AREAS

(71) Applicant: enVerid Systems, Inc., Needham, MA (US)

(72) Inventors: Sharon PERL-OLSHVANG, Pardes Hanna-Karkur (IL); Udi MEIRAV, Newton, MA (US)

(73) Assignee: enVerid Systems, Inc., Needham, MA (US)

(21) Appl. No.: 15/775,151

(22) PCT Filed: Nov. 17, 2016
(86) PCT No.: PCT/US16/62577

§ 371 Date: May 10, 2018

Related U.S. Application Data
(60) Provisional application No. 62/256,727, filed on Nov. 18, 2015.

(51) Int. Cl. B01D 53/04; F24F 3/16

(52) U.S. Cl. CPC B01D 53/0407; F24F 3/16; B01D 2257/11; F24F 2110/68; B01D 2259/4508; F24F 2003/1696; B01D 2258/06

(57) ABSTRACT

Embodiments of the present disclosure are directed to a method for reducing radon contained in indoor air from an indoor area. In some embodiments, indoor air containing radon from indoor air is directed through at least one layer of an adsorbent medium configured for capturing radon from air. In some embodiments, the indoor air is directed through the adsorbent medium at a predetermined flow-rate such that the fraction of radon captured in a single pass though the assembly is very low, approximately 10% or less of the concentration of radon in the incoming air. The low capture rate is offset by multiple passes of the air through the medium.

### RELATED APPLICATIONS

This disclosure claims benefit of and priority to U.S. provisional patent application No. 62/256,727, filed Nov. 18, 2015, titled “Compact Radon Remover Assembly,” the entire disclosure of which is herein incorporated by reference.

### TECHNICAL FIELD

Embodiments of the present disclosure generally relate to air treatment and more particularly to radon removal from indoor environments.

### BACKGROUND

Radon-222 and its radioactive-decay progeny are naturally forming indoor air contaminants and a leading cause of lung cancer. It is particularly common in basements and ground floors of homes, where radon seeps in from the ground. Radon mitigation remains an important part of indoor air quality and public health. Currently the only available solution for homes with elevated radon is constant ventilation, either inside the house or underneath it. It is desirable to have a compact, reliable and inexpensive device that can easily be brought into affected areas and reduce radon levels without relying on external ventilation.

Radon is a noble gas with very weak affinity to most surfaces. Although radon can be weakly adsorbed onto surfaces of certain adsorbents, the capture efficiency of radon from an air stream in a practically-sized adsorption scrubber is very low. Thus, a cost-effective adsorption based solution for radon mitigation has not been available to date. Indeed, the only commercially available radon mitigation solutions available for homes today are methods to reduce the amount of infiltration, rather than remove radon from the indoor air.

### SUMMARY OF DISCLOSURE

Embodiments of the present disclosure present a low, single-pass capture efficiency methods, systems and devices, some embodiments of which include a multi-pass adsorbent based scrubber configured to slowly reduce the radon levels in an unventilated room (or, with respect to some embodiments, in a partially unventilated room as well as in a ventilated room) by repeated air passes in a continual operation mode (for example), eventually achieving substantial reduction of the steady state radon levels to an acceptable concentration. The inherent tradeoff between the volume and speed of air flow to the capture efficiency allows operating condition where a small, cost effective air treatment assembly can successfully reduce radon levels in unventilated rooms, if the right adsorbent medium is utilized.

Accordingly, in some embodiments of the present disclosure, a self-contained air treatment assembly is provided with a casing/enclosure, an adsorbent medium, an electric fan, an air inlet and an air outlet. In some embodiments, the assembly is portable and can be placed or mounted on the floor or in any other suitable location in the affected room. It can be powered by an electric outlet or by a battery if an outlet is not available.

In some embodiments, the fan causes air to be drawn in from the room through the inlet, and through the medium, after which it is directed to flow through the outlet and back to the room. As the air stream passes through the medium, radon atoms are captured by the mechanism of physisorption and removed from the airstream. The capture of radon is only partial, but continual circulation of the same air though the assembly results in multiple passes through the medium and thereby gradually allows for substantial reduction of radon levels.

In some embodiments, a method for reducing radon contained in indoor air from an indoor area is provided and comprises directing indoor air containing radon from an indoor area through at least one layer of an adsorbent medium configured for capturing radon from air. Such embodiments may include one and/or another of the following additional features/functionality:
the indoor air is directed through the at least one layer of the adsorbent medium at a predetermined flow-rate such that the fraction of radon captured in a single pass though the assembly (r) is approximately 10% or less of the concentration of radon in the incoming air;
where r is approximately 5% or less, 3% or less, or even 1% or less;
the adsorbent medium is selected from the group consisting of: granular activated carbon, synthetic activated carbon monoliths, carbon fiber cloth, molecular sieve, silica, alumina, zeolite, metal-organic frameworks, titanium oxide, magnesium oxide a high-surface area metal oxide, a polymer adsorbent, or a combination of any of the foregoing;
the adsorbent medium is formed by partially or completely coating, soaking, suspending or infusing a porous solid, high-surface area solid, or fibrous material with a liquid, whereby the liquid captures radon by adhesion, solution or absorption. The solid can be carbon, silica, zeolite, clay, alumina, polymer, or any other suitable mineral, ceramic, or fiber based material. The liquid can be water, mineral oil, silicone, glycol, amine, or any other suitable liquid.
the adsorbent medium is configured in a flat bed or in cylindrical geometry such that one of the incoming and outgoing air streams is axial and the other is radial, relative to the cylindrical geometry of the adsorbent medium;
a filter for removing particulates from the indoor air prior to reaching the adsorbent medium, where the filter may be a HEPA filter;
sensing and/or measuring at least one property of the indoor air via at least one sensor, where the at least one property comprises radon detection and/or concentration, and/or alpha-particle detection and/or concentration; and
at least one of: controlling the fan, receiving sensor readings, and exchanging digital information with other devices.

In some embodiments, an air treatment assembly for reducing radon contained in indoor air of an indoor area is provided and includes an enclosure with an inlet and an outlet, at least one layer of adsorbent medium configured for capturing radon from air, and a fan configured for driving an airflow through the enclosure and through the adsorbent medium at a predetermined flow-rate. The fan causes incoming indoor air from an indoor area to be drawn into the inlet, through the adsorbent medium, and expelled back into the room via the outlet and the predetermined flow-rate is configured such that the fraction of radon captured in a single pass though the assembly (r) is approximately 10% or less of the concentration of radon in the incoming air.

Such embodiments may include one and/or another of the following additional features/functionality:
the adsorbent medium comprises an activated carbon fiber cloth (which may be pleated);
the adsorbent medium is selected from the group consisting of: granular activated carbon, synthetic activated carbon monoliths, molecular sieve, silica, alumina, zeolite, metal-organic frameworks, titanium oxide, magnesium oxide a high-surface area metal oxide, a polymer adsorbent, or a combination of any of the foregoing;
the adsorbent medium is formed by partially or completely coating, soaking, suspending or infusing a porous solid, high-surface area solid, or fibrous material with a liquid, whereby the liquid captures radon by adhesion, solution or absorption. The solid can be carbon, silica, zeolite, clay, alumina, polymer, or any other porous mineral, ceramic, or fiber based material. The liquid can be water, mineral oil, silicone, glycol, amine, or any other suitable liquid.
the adsorbent medium is supported by at least one of: a rigid mesh, a lamination, and a frame;
the adsorbent medium is configured in a flat bed or cylindrical geometry such that one of the incoming and outgoing air streams is axial and the other is radial, relative to the cylindrical geometry of the adsorbent medium;
r is approximately 10% or less, 5% or less, 3% or less, 1% or less, or between about 10% and 50%;
a filter configured for removing particulates from the incoming air before reaching the adsorbent medium, where the filter may be a HEPA filter;
at least one sensor configured to measure one or more properties of air, where the at least one sensor comprises a radon sensor or an alpha-particle detector (for example),
electronic circuitry (which may be or may include a processor) configured to at least one of: controlling the fan, receiving sensor readings, and exchanging digital information with other devices (where the processing is configured with computer instructions operating thereon to perform such functions); and
the fan comprises a variable speed fan.

In some embodiments, a method for reducing radon in indoor air from an indoor area is provided and comprises providing one or more air treatment assemblies according to any disclosed embodiments thereof, positioning the assembly within an indoor area, directing indoor air containing radon from an indoor area through the assembly such that the assembly captures at least some of the radon from the indoor air, and expelling the radon reduced air back into the room.

In some embodiments, a method for reducing the concentration of radon in a total indoor-air volume of an indoor area to at least an acceptable predetermined concentration level is disclosed. The method may comprise the steps of receiving an airflow of radon-entrained indoor-air from an indoor area via an inlet of an enclosure, wherein the enclosure includes an adsorbent medium configured to capture only a fraction of radon entrained in an airflow flowing over and/or through the adsorbent medium; flowing the airflow of radon-entrained indoor-air over and/or through the adsorbent medium at an airflow volume rate; and capturing, by the adsorbent medium, only between about 0.1 to about 10 percent of the concentration of radon contained in the airflow of radon-entrained indoor-air entering the enclosure. In some embodiments, the airflow volume rate may be determined by a fan.

In some embodiments, the adsorbent medium comprises an activated carbon fiber cloth and/or may be selected from the group consisting of: granular activated carbon, synthetic activated carbon monoliths, molecular sieve, silica, alumina, zeolite, metal-organic frameworks, titanium oxide, magnesium oxide a high-surface area metal oxide, a polymer adsorbent, or a combination of any of the foregoing. In some embodiments, the adsorbent medium comprises at least one of a granular, porous, and fibrous solid that is coated and/or infused with a liquid, or wherein the solid is suspended in a liquid. The liquid, for example, can be selected from one of water, oil, alcohol, polyol, glycol, solvent, and silicone. In some embodiments, the adsorbent medium can be configured in a cylindrical geometry such that one of the incoming and outgoing airflows axial and the other is radial, relative to the cylindrical geometry of the adsorbent medium.

In some embodiments, the method for reducing the concentration of radon further comprises the step of providing a filter for removing particulates from the indoor air prior to reaching the adsorbent medium. For example, the filter may include a HEPA filter. The method may further comprise sensing and/or measuring at least one property of the indoor-air via at least one sensor. In some embodiments, the at least one property may include radon presence and/or concentration, and/or alpha-particle detection and/or concentration. In some embodiments, the method may also comprise the step(s) of at least one of: controlling a fan for determining the airflow volume rate, receiving sensor readings, and exchanging digital information with other devices. In some embodiments, controlling the fan may include the step of changing a speed and/or a time that the fan is activated, so as to enable the concentration of radon in the total indoor-air volume of the indoor area to be reduced to at least the acceptable, predetermined concentration.

In some embodiments, a method for reducing the concentration of radon in the total indoor-air volume of an indoor area to at least an acceptable predetermined concentration level is disclosed. The method may comprise the step of configuring at least one of one or more properties of an adsorbent medium, and a volume airflow rate of the airflow of radon-entrained indoor-air being flowed over and/or through the adsorbent medium, such that upon exposure to an airflow of radon-entrained indoor-air, only a fraction of radon entrained therein is captured. The method may also include the steps of receiving the airflow of radon-entrained indoor-air from an indoor area via an inlet of an enclosure at the volume airflow rate, wherein the enclosure includes the adsorbent medium; flowing the airflow of radon-entrained indoor-air over the adsorbent medium at the volume airflow rate; and capturing, by the adsorbent medium, only between about 0.01 to 10 percent of the concentration of radon contained in the airflow of radon-entrained indoor-air entering the enclosure.

In some embodiments, the configuring step may include configuring a period of time that a volume airflow rate is flowed over and/or through the adsorbent medium. The one or more properties may comprise: a type of adsorbent material, a size and/or shape of the adsorbent material, an area of the adsorbent material, and/or an arrangement of the adsorbent material. Such period of time can be between 1-24 hours, any time periods therebetween.

In some embodiments, an air treatment assembly configured to reduce the concentration of radon in the total indoor-air volume of an indoor area to at least an acceptable predetermined concentration level is disclosed. Such an assembly may comprise an enclosure with an inlet and an outlet; an adsorbent medium configured for capturing only between 0.1 and 10 percent of radon from a radon-entrained airflow; and a fan configured for driving an airflow at a volume airflow rate through the adsorbent medium. In some embodiments, the fan causes an airflow of radon-entrained indoor-air of an indoor area to be drawn into the inlet, over and/or through the adsorbent medium, and expelled back into the room via the outlet.

In some embodiments, at least the volume airflow rate can be configured such that the concentration of radon in the total indoor-air volume of the indoor area is eventually reduced to at least an acceptable, predetermined concentration level. Further, in some embodiments, at least the volume airflow rate can be configured such that the concentration of radon in the total indoor-air volume of the indoor area is eventually reduced to at least an acceptable, predetermined concentration level and thereafter maintained upon the fan being in continual operation (for example).

In some embodiments, the adsorbent medium can be configured for capturing: less than 10 percent; less than 9 percent; less than 8 percent; less than 7 percent; less than 6 percent; less than 5 percent; less than 4 percent; less than 3 percent; less than 2 percent; or less than 1 percent, of the concentration of radon contained in the airflow of radon-entrained indoor-air. The adsorbent medium may include an activated carbon fiber cloth, and/or may be selected from the group consisting of: granular activated carbon, synthetic activated carbon monoliths, molecular sieve, silica, alumina, zeolite, metal-organic frameworks, titanium oxide, magnesium oxide a high-surface area metal oxide, a polymer adsorbent, or a combination of any of the foregoing. In some embodiments, the carbon fiber cloth is pleated. In some embodiments, the adsorbent medium may comprise at least one of a granular, porous or fibrous solid that is coated and/or infused with a liquid, wherein the liquid may be selected from one of water, oil, alcohol, solvent, silicone. In some embodiments, the adsorbent medium may be supported by at least one of: a rigid mesh, a lamination, and a frame. Further, the adsorbent medium may be configured in a cylindrical geometry such that one of the incoming and outgoing airflows is axial and the other is radial, relative to the cylindrical geometry of the adsorbent medium.

In some embodiments, the air treatment assembly may further comprise a filter configured for removing particulates from the incoming air before reaching the adsorbent medium. The filter may include a HEPA filter. In addition, the assembly may also include at least one sensor configured to measure one or more properties of air, wherein the at least one sensor comprises a radon sensor or an alpha-particle detector. In some embodiments, the assembly may also include an electronic circuitry configured to at least one of: control at least one of the fan speed and time the fan is active, receive sensor readings, and exchange digital information with other devices. The fan may include a variable speed fan.

In some embodiments, a method for reducing the concentration of radon in the total indoor-air volume from an indoor area to at least an acceptable predetermined concentration level is disclosed. The method comprises the steps of providing one or more air treatment assemblies disclosed above; positioning the assembly within an indoor area; directing an airflow of radon-entrained indoor-air from an indoor area through the assembly such that the adsorbent material captures only between 0.1 and 10 percent of the radon entrained in the airflow of indoor-air, the airflow existing the assembly comprising treated indoor-air; and expelling the treated indoor-air back into the indoor area, wherein the concentration of radon in the total indoor-air volume of the indoor area is eventually reduced to at least an acceptable, predetermined concentration level.

In some embodiments, a method for reducing the concentration of radon in a total indoor-air volume of an indoor area to at least an acceptable predetermined concentration level is disclosed. The method may comprise the steps of receiving an airflow of radon-entrained indoor-air from an indoor area via an inlet of an enclosure, wherein the enclosure includes an adsorbent medium configured to capture only a fraction of radon entrained in an airflow flowing over and/or through the adsorbent medium; flowing the airflow of radon-entrained indoor-air over and/or through the adsorbent medium at an airflow volume rate over a period of time (e.g., between about 1 and about 24 hours, and time periods therebetween); and capturing, by the adsorbent medium, only between about 0.1 to about 10 percent of the concentration of radon contained in the airflow of radon-entrained indoor-air entering the enclosure, wherein the concentration of radon in the total indoor-air volume of the indoor area is reduced to at least an acceptable, predetermined concentration after the period of time. In some embodiments, the acceptable, predetermined concentration of radon in the total volume of indoor-air can be maintained via a continual airflow of radon-entrained indoor-air through the adsorbent medium.

These and other embodiments will be even more evident and clear with reference to the supplied drawings (briefly described below), and the detailed description that follows.

### BRIEF DESCRIPTIONS OF THE DRAWINGS

The principles and operations of the systems, apparatuses and methods according to some embodiments of the present disclosure may be better understood with reference to the drawings, and the following description. These drawings are given for illustrative purposes only and are not meant to be limiting.

FIG. 1A is a schematic illustration of an air treatment assembly for radon removal and

FIGS. 1B and 1C are each a schematic illustration of a filter used in the air treatment assembly, constructed and operative according to an embodiment of the present disclosure;

FIG. 2 is a schematic illustration of multiple radon removal assemblies located on a floor of a basement or room and the circulating air created thereby; and

FIG. 3 is a schematic illustration of an air treatment assembly for radon removal in a cylindrical configuration.

### DETAILED DESCRIPTION

The inherently low capture rate of radon by most adsorbents is an important consideration in developing a practical method to remove radon from indoor air. Another important consideration is that indoor radon levels are determined by the interplay between very slow infiltration of radon and its natural elimination by radioactive decay. A third important consideration is the fundamental trade-off in adsorption scrubbing, between the flow rate of an air stream through an adsorbent layer and the capture efficiency of the target contaminant. The slower the flow, the longer the “dwell time” of the air in the adsorbent layer, thereby generally increasing the capture efficiency. However, the increased capture efficiency comes at the expense of a smaller amount of air that is treated in a given amount of time. In the case of radon, a noble gas with very weak affinity to most surfaces, high capture efficiency would require extremely slow flow rates or very large volumes of sorbent.

The ability to implement an indoor radon scrubber, proposed herein, is based on a compact design and a method of deployment where a very low capture efficiency is offset by multiple passes of the same air volume though the adsorbent medium over a time that is or shorter than the replacement rate of radon, which depends on the source and the decay half-life of radon. Thus, rather than attempt to implement very large sorbent volumes and/or very slow air flow to achieve complete single-pass capture, as is known in the art adsorption, a different approach is taken to achieve a cost-effective solution for indoor radon.

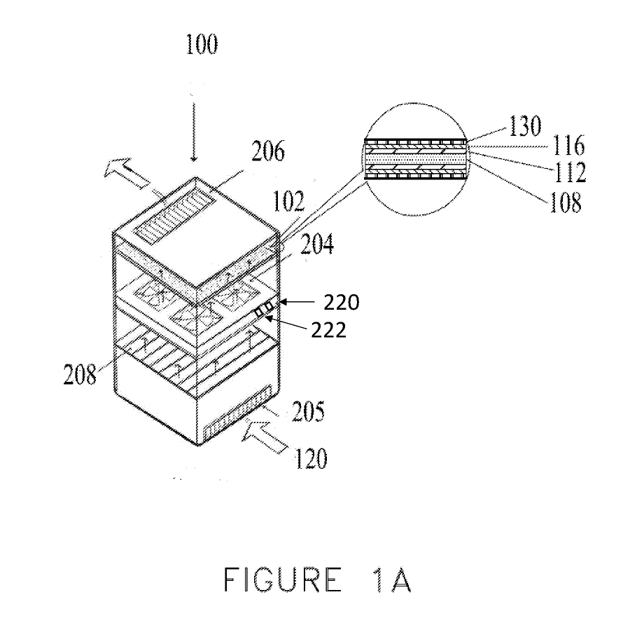

Reference is made to FIG. 1A, which is a schematic illustration of an air treatment assembly 100 comprising a radon adsorbent filter 102 for reducing radon concentration in air. In some embodiments, the filter 102 comprises an adsorbent medium. In some embodiments, the adsorbent medium may comprise a carbon cloth medium. The carbon cloth medium may be formed of a pleated sheet of activated carbon fiber cloth 108. The carbon fiber cloth 108 may comprise a woven fabric or a sheet of intertwined carbon fibers. Activated carbon fiber cloths may be commercially available. The carbon fiber cloth can be formed into substantially planar sheets with a relatively flat, straight surface and supported by a frame, lamination or a mesh 112, which may be a substantially rigid frame or mesh (mesh, screen and/or other permeable surface; these terms/phrases being used interchangeably), as seen in FIG. 1A. In some embodiments, the carbon fiber cloth 108 can be laminated with a permeable material 116, like filter paper or synthetic fibers, to give it more structural strength, stiffness or protection from dust particles.

In some embodiments, with or without lamination, the carbon fiber cloth 108 can be pleated in an accordion-like form, as seen in FIG. 1C. The pleated or curved cloth may also be supported by the frame or mesh 112 to maintain its form. In some embodiments, the pleating may increase the surface area and reduce the pressure drop of flowing air 120.

In some embodiments, flat or pleated carbon fiber cloths 108 can be inserted into an enclosure 130 comprising a framed (e.g., rectangular) sheet. The enclosure 130 can be constructed of any sufficiently rigid material, such as metal, plastic or paperboard. In some embodiments, the enclosure 130 may comprise an aluminum frame. In some embodiments, the enclosure 130 may comprise plastic polymers. In some embodiments, the enclosure 130 may comprise frames based on paper, cardboard or recycled materials.

In some embodiments, the carbon fiber cloth 108 may be formed into one of several commonly used three-dimensional filter forms, including but not limited to a V-bank shape. As seen in FIG. 1B, for example, a plurality of carbon fiber cloths supported by enclosures may be provided and arranged in a V-bank arrangement (for example).

In some embodiments, the carbon fiber cloth 108 may be formed as a cylindrical filter (not shown), where air flows radially between an inside and outside surface of the cylinder (for example). In some embodiments, the carbon fiber cloth 108 may be configured with a cylindrical geometry such that one of the incoming and outgoing air streams is axial and the other is radial, relative to the cylindrical geometry of the adsorbent medium.

In some embodiments, other forms of activated carbon are used instead of cloth. Certain types of granular activated carbon can be used in various configurations. The carbon maybe of plant source, like coconut shells, or synthetic, produced from bulk plastics, polymers or hydrocarbons. In one embodiment, granular carbon is held between two permeable sheets or screens that hold the carbon granules in place while allowing air to flow through. These screens can then be shaped into forms similarly to the ones described above for the cloth, such as a pleated accordion form, a v-bank of a cylinder. Yet in other embodiments, permeable carbon monoliths can be used as the adsorbent (sorbent, adsorbent, adsorbent material, adsorbent medium, these terms/phrases being used interchangeably). Such monoliths can be made by attaching small particles of carbon through a process of adhesion of compressions, with or without additive materials to promote the adhesion. Alternatively, monoliths can be formed from natural or synthetic materials forming activated carbon monoliths and subsequently carbonized or activated through a controlled thermal process.

In some embodiments, the radon adsorbent filter may include other solid sorbents that can be used as the medium for capturing the radon gas. Suitable sorbent materials include silica, alumina, zeolites, molecular sieves, titanium oxide, magnesium oxide or any other high-surface area metal oxide. In some embodiments, high surface area polymer and metal-organic frameworks can be used as the radon capture medium.

In some embodiments, the solid adsorbent may be coated or infused with liquid to improve the adsorption of radon. Radon is known to be absorbed in water and other liquids. The liquid, in turn, can be supported or suspended by a porous or fibrous solid, thereby creating a composite radon adsorbent. Alternatively small solid granules can be suspended in a liquid. Any suitable liquid can be used with the appropriate solid particles, granules or fibers. In some embodiments, the liquid used can be aqueous or water based. In other embodiments, the liquid can be a natural or synthetic oil, such as silicone, plant or mineral oil. In other embodiments, the liquid can be an alcohol, including a glycol or a polyol, or an organic solvent.

A fan 204 may be used to force air 120 to flow through the radon adsorbent filter 102. Air enters the enclosure of the assembly 100 through an inlet 205 and exits through an outlet 206. The fan may be upstream from the filter, “pushing” air through it, or downstream, pulling air through the filter.

As air passes through the carbon fiber cloth 108, radon atoms come into close proximity with the highly porous carbon surface, and radon atoms may be adsorbed to the surface by a mechanism known in the art as physisorption. Radon is a noble gas that is largely immune to chemical reactions, but its atoms can attach to solid surfaces via the van der Waals force. In general, physisorption of radon depends on the surface properties of the sorbent material as well as the concentration of radon in the air and the temperature.

A particle pre-filter or filter 208 may also be provided for removing dust and airborne particles from the incoming air 120. The particle filter 208 may be formed of any suitable material, such as a filter paper or synthetic fiber cloth. In some embodiments the particle filter can be selected to meet very high standards such as High-Efficiency Particulate Arrestance (HEPA). The filter can be configured for easy removal and replacement. Particle filtration can serve to protect the primary radon-capture medium from airborne dust and debris.

Radon-222 (²²²Rn) and some of its decay progeny, such as lead isotopes, may attach to airborne dust particles. Once attached to these particles, these atoms are less likely to be adsorbed to the primary radon capture medium. The particle filter can also serve to improve the capture of radon and of its decay products that have attached to airborne dust particles. In indoor environments where a significant number of airborne particles capture radon and its decay progeny, the filtration of these airborne particles can be part of a radon mitigation solution.

In some embodiments, the amount of radon adsorbed may depend on the amount of radon present in the incoming air as well as the dwell time of the air in the vicinity of the adsorbent medium. The dwell time, in turn, depends on the air flow speed and the amount or thickness of the adsorbent medium.

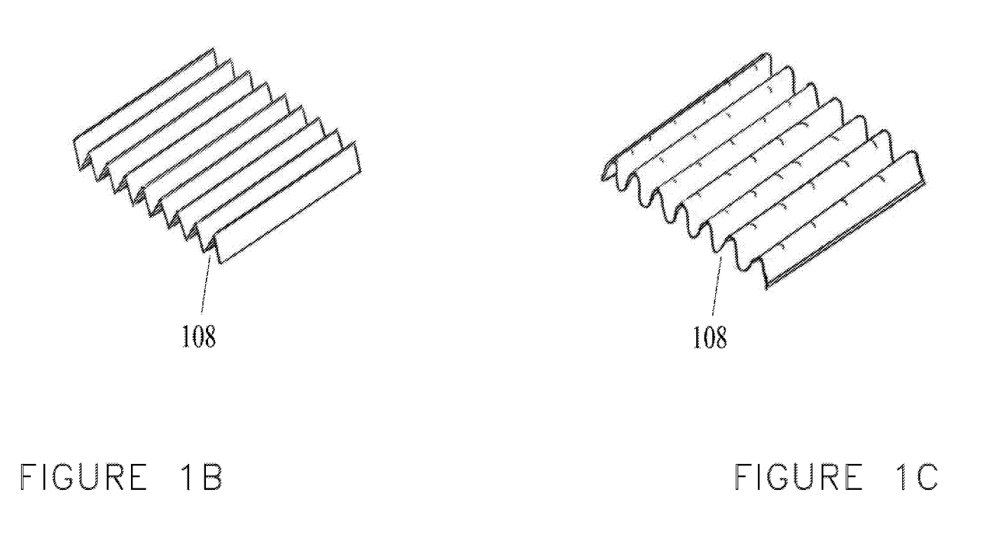

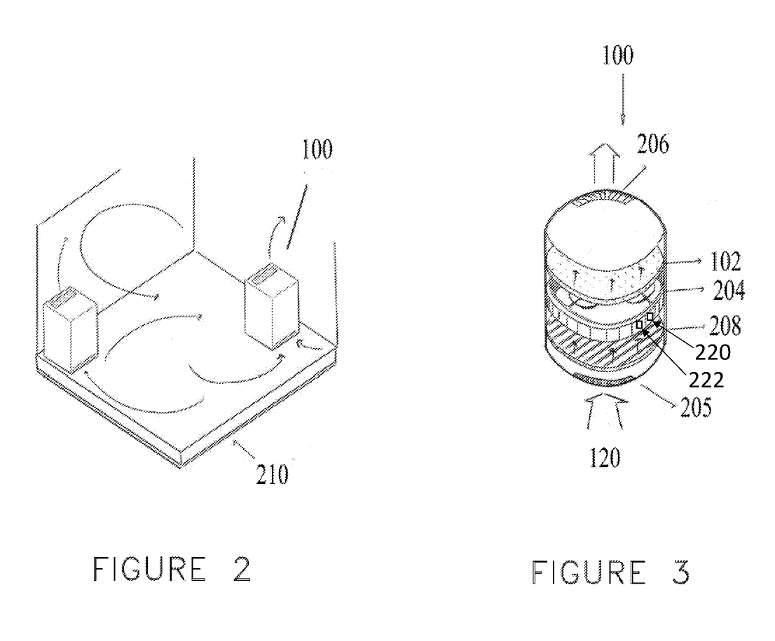

Accordingly, in some embodiments, one or more such assemblies 100 may be placed in any suitable location within the room. FIG. 2 schematically illustrates a basement 210 with two separate assembly units 100. Each assembly unit 100 draws air from its vicinity and expels it back into the room after passing through the cloth or the adsorbent medium and having the radon removed.

The air flow creates an air circulation path in the room, thereby eventually all or at least a portion of the air in the room gets treated. Since radon is added slowly in a room and has a half-life of 3.8 days, a small amount of circulation may be sufficient. Indeed, as long as the circulation is such that the cumulative flow of the scrubber over 3.8 days is significantly more than the room's total air volume, the air circulates at a rate higher than the rate of radon replacement.

Since the same air volume passes multiple times through the same medium, it is not necessary or even important that the capture efficiency of the trace radon in a single pass is 100% or even close to 100%. The capture efficiency depends in part on the dwell time of the air in the vicinity of the sorbent surface. If the air flow is reduced, dwell time is longer and a higher capture efficiency is likely to be achieved. But at the same time, less of the air volume may be treated and as a result fewer radon atoms may be removed from the room.

The radon removal rate R (atoms per second; it can also be expressed in terms of Becquerel/second) by the sorbent is given by the product

R=rFC

Where F is the air flow rate typically expressed in liters per second or LPS (although liters per minute, cubic feet per minute and cubic meters per hour are also commonly used), r is the single-pass efficiency of radon capture (as a percentage of incoming concentration), and C is the concentration of radon in the incoming air flow. In general, r depends on the flow rate, the temperature, the incoming concentration, and the sorbent itself, including its intrinsic surface properties as well as the amount and configuration of the overall sorbent mass relative to the air flow. Increasing F may generally cause a decrease in r (due to the shorter dwell time) but can still increase their multiplicative product and hence the value of R. Thus, in a non-limiting example, the optimal operating point may have a relatively low r, indeed as low as a few percent.

The following is a non-limiting example for a system for radon removal. Radon steady state level is determined by the ratio of the rate of generation of the radon to the rate of elimination of radon, the latter being the sum of elimination by radioactive decay, ventilation of the air in the enclosed room and adsorptive removal. With no ventilation or adsorption, and a constant source of radon from the ground or the building materials, the steady-state radon level (typically expressed in Becquerel per cubic meter or Bq/m³) is the ratio of the generation rate to the decay rate, divided by the room volume. Given the radioactive decay half-life of radon is about 3.8 days, the level of radon in an unventilated room is the approximately 3.8/ln 2≈5.5 times the daily generation rate. Thus for example, a source of 1000 Bq/day, in a room that has a volume of 80 m³ would lead to 5500/80=70 Bq/m³. Typically, the nature of this “source” is external infiltration of radon from the ground. A small unit that draws in 5 liters per second (18 m³ per hour) of untreated indoor air would treat the equivalent of the entire room's volume of 80 m³, or 80,000 liters, in 80,000/5=16,000 seconds, namely under 4.5 hours, amounting to over 5 passes per day of the entire volume. Even if the single-pass removal rate of the medium is only 10% of the radon concentration in the air stream, the entire volume of the room passes though the assembly more than 5 times a day and the effective reduction of radon is much higher than the single pass efficiency.

A more detailed calculation follows. The amount of radon in a room, N(t), can change over time due to the combination of infiltration, radioactive decay and capture (assuming no ventilation). The rate of change, or time derivative, therefore obeys the following differential equation for the time derivative of N(t):

$$\frac{dN}{dt} ( t ) = {n}_{s} - λ N ( t ) - rFC$$

Where nₛ is the rate of infiltration or production of new radon, λ is the decay rate of radon, and C=N/V where V is the room volume. The rate of radioactive decay λ is related to the half-life of radon T_{1/2} by

λ=ln 2/T_{1/2}

In steady state, N(t) is constant in time (denoted simply as N) and its time-derivative vanishes, which simplifies the equation above to:

$${n}_{s} = N ( λ + \frac{rF}{V} )$$

And therefore

$$N = {n}_{s} \times \frac{1}{λ + \frac{rF}{V}}$$

We define the mitigation quotient, Q, as the ratio of steady state radon value without an adsorption scrubber (the value of N above when F is set to zero) to its value with a multi-pass scrubber, for a given room volume V and fixed source rate nₛ. For the case of no scrubbing, the steady-state value of N is obtained by the same formula above while setting F=0. The resulting expression for the mitigation quotient is obtained by dividing the two cases and canceling nₛ from the numerator and denominator, namely:

$$Q = \frac{λ + \frac{rF}{V}}{λ} = 1 + \frac{rF}{λ V}$$

For the non-limiting example above, r=10%=0.1, V=80,000 liters and F=5 LPS, and for radon 222 the half-life of 3.8 days corresponds to λ≈2.1×10⁻⁶/sec, which leads to Q=3.96. In other words, approximately a four-fold reduction in steady-state radon levels despite the modest air flow and 10% single-pass scrubbing efficiency.

In certain embodiments, the flow rate F is designed for a given configuration that optimizes mitigation performance and overall cost, including assembly size and power usage, where r may be substantially less than 100%. In one embodiment, corresponding to the example above, the flow and sorbent configuration are set such that r is approximately 10% or less. In one embodiment, the flow and sorbent configuration are set such that r is approximately 50% or less. In one embodiment, the flow and sorbent configuration are set such that r is approximately 1% or less. In another embodiment the flow and sorbent configuration are set such that r is approximately 5% or less. In one embodiment the flow and sorbent configuration are set such that r is above 50%. In one embodiment the flow and sorbent configuration are set such that r is approximately between 25%-50%. In one embodiment the flow and sorbent configuration are set such that r is approximately between 10%-50%. In one embodiment the flow and sorbent configuration are set such that r is approximately between 5%-50%. In one embodiment the flow and sorbent configuration are set such that r is approximately between 5%-20%. In one embodiment the flow and sorbent configuration are set such that r is approximately between 1%-20%. The sorbent and flow settings can be designed to meet the requirements of the room in question and the required mitigation quotient.

The value of r depends on the sorbent intrinsic properties and its configuration, including its thickness. In some embodiments, in the case of a cloth-based sorbent, multiple layers can be used to increase r. The increased amount of sorbent adds material cost and flow resistance, which may be weighed against the benefit of higher mitigation quotient, Q, as well as against the option of increased F as an alternative method to achieve higher Q.

In some embodiments, the system can be configured with variable speed fans that modify the air flow rate so as to optimize the system performance under changing conditions. The flow rate can be adjusted to compensate for temperature, which in turn can be read from a built in sensor 220 or any other suitable sensor. The flow rate can also be changed in response to wireless signals received from a remote device. The flow rate can be adjusted to counteract increased radon levels if a radon detector reading is available.

In some embodiments the adsorption medium can be configured in a removable insert or module to allow easy removal and replacement, as the medium may lose its efficacy over time or become saturated with dust particulates, microbes, adsorbed vapors or any other contaminants, or otherwise degrade physically or chemically. In some embodiments the insert can be cleaned or regenerated for subsequent reuse.

The choice of the volume of carbon cloth or other adsorbent medium can be influenced by a number of considerations. A larger sorbent mass may cost more and have generally larger capacity. A thicker medium may have higher efficiency r but also higher flow resistance requiring more fan power and potentially producing more fan noise. A smaller sorbent surface may reduce the size and cost of the system but again requires faster air flow or results in lower F.

In one embodiment, a total surface of 4000 cm² cloth receives 4 LPS of air flow, namely 4000 cm³/sec. This implies a face velocity of 1 cm/sec at the cloth surface. Radon capture efficacy, r, at this velocity through a five-layer configuration of the carbon cloth used in our tests is estimated at 2%. This system can be extremely compact, and the flow resistance of a single layer of cloth at this velocity creates a modest pressure drop of under 20 Pascal. The efficacy r can be increased as needed by using more layers of the same cloth. These can gradually increase the flow resistance and cost but in general may still provide for a relatively low cost and effective device for removing radon from a room.

Radon and its progeny may accumulate on the adsorbent and eventually decay, however radon quantities are very small. In the above non-limiting example, if the ambient radon level is a typical 100 Bq/m³, this corresponds to approximately 50,000 radon atoms per liter of air. With a 2% capture rate, 1,000 radon atoms per second are captured by the sorbent. With 31.5 million seconds per year, the annual buildup of radon is 3.1×10¹⁰ atoms/year and over a 10-year period, 3.1×10¹¹ atoms. The captured radon can decay to radioactive lead isotope ²¹⁰Pb within days. Multiplying by 210, the atomic weight of the lead isotope, and dividing by Avogadro's number, 6.02×10²³, the estimated 10-year accumulated mass is approximately 100 picograms. Other capture rates or ambient levels would lead to different results.

In certain embodiments, the system is equipped with electronic circuitry 222 that controls its operations. The circuitry 222 may include one or more microprocessors, and a plurality of sensors or communication modules. In some embodiments, the sensors 220 may include a radon sensor, an alpha particle detector, or any other gas sensors that monitor the air quality and the presence of various contaminants or components in the air. The electronic circuitry 220 may be configured to perform at least one of controlling the fan, receiving sensor readings, and exchanging digital information with other devices.

In some embodiments, the system has one or more wireless electronics communications components that allow the system to send or receive digital information. The wireless communication can follow any acceptable protocol including but not limited to Wi-Fi, Bluetooth®, cellular communications, LoRa®. The system may have internet connectivity and be an internet-of-things (IoT) site. The wireless connection can be used to send or receive air quality readings and to provide a remote monitoring device information about the systems operating condition.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be an example and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure. Some embodiments may be distinguishable from the prior art for specifically lacking one or more features/elements/functionality (i.e., claims directed to such embodiments may include negative limitations).

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any and all references to publications or other documents, including but not limited to, patents, patent applications, articles, webpages, books, etc., presented anywhere in the present application, are herein incorporated by reference in their entirety. Moreover, all definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method for reducing the concentration of radon in a total indoor-air volume of an indoor area to at least an acceptable predetermined concentration level, the method comprising:
receiving an airflow of radon-entrained indoor-air from an indoor area via an inlet of an enclosure, wherein the enclosure includes an adsorbent medium configured to capture only a fraction of radon entrained in an airflow flowing over and/or through the adsorbent medium;
flowing the airflow of radon-entrained indoor-air over and/or through the adsorbent medium at an airflow volume rate; and
capturing, by the adsorbent medium, only between about 0.1 to 10 percent of the concentration of radon contained in the airflow of radon-entrained indoor-air entering the enclosure.

2. The method of claim 1, wherein the adsorbent medium comprises an activated carbon fiber cloth.

3. The method of claim 1, wherein the adsorbent medium is selected from the group consisting of: granular activated carbon, synthetic activated carbon monoliths, molecular sieve, silica, alumina, zeolite, metal-organic frameworks, titanium oxide, magnesium oxide a high-surface area metal oxide, a polymer adsorbent, or a combination of any of the foregoing.

4. The method of claim 1, wherein the adsorbent medium comprises at least one of a granular, porous, and fibrous solid that is coated and/or infused with a liquid, or wherein the solid is suspended in a liquid.

5. The method of claim 4, wherein the liquid is selected from one of water, oil, alcohol, polyol, glycol, solvent, and silicone.

6. The method of claim 1, wherein the adsorbent medium is configured in a cylindrical geometry such that one of the incoming and outgoing airflows axial and the other is radial, relative to the cylindrical geometry of the adsorbent medium.

7. The method of claim 1, further comprising providing a filter for removing particulates from the indoor air prior to reaching the adsorbent medium.

8. The method of claim 7, wherein the filter comprises a HEPA filter.

9. The method of claim 1, further comprising sensing and/or measuring at least one property of the indoor-air via at least one sensor.

10. The method of claim 9, wherein the at least one property comprises radon presence and/or concentration, and/or alpha-particle detection and/or concentration.

11. The method of claim 1, wherein the airflow volume rate is determined by a fan.

12. The method of claim 1, further comprising at least one of: controlling a fan for determining the airflow volume rate, receiving sensor readings, and exchanging digital information with other devices.

13. The method of claim 12, wherein controlling the fan comprises changing a speed and/or a time that the fan is activated, so as to enable the concentration of radon in the total indoor-air volume of the indoor area to be reduced to at least the acceptable, predetermined concentration.

14. A method for reducing the concentration of radon in the total indoor-air volume of an indoor area to at least an acceptable predetermined concentration level, the method comprising:
configuring at least one of the following such that upon exposure to an airflow of radon-entrained indoor-air, only a fraction of radon entrained therein is captured:
one or more properties of an adsorbent medium, and
a volume airflow rate of the airflow of radon-entrained indoor-air being flowed over and/or through the adsorbent medium,
receiving the airflow of radon-entrained indoor-air from an indoor area via an inlet of an enclosure at the volume airflow rate, wherein the enclosure includes the adsorbent medium;
flowing the airflow of radon-entrained indoor-air over the adsorbent medium at the volume airflow rate; and
capturing, by the adsorbent medium, only between about 0.01 to 10 percent of the concentration of radon contained in the airflow of radon-entrained indoor-air entering the enclosure.

15. The method of claim 14, wherein configuring at least one of the following includes configuring a period of time that a volume airflow rate is flowed over and/or through the adsorbent medium.

16. The method of claim 14, wherein the one or more properties comprise:
a type of adsorbent material,
a size and/or shape of the adsorbent material,
an area of the adsorbent material, and
an arrangement of the adsorbent material.

17-33. (canceled)

34. A method for reducing the concentration of radon in a total indoor-air volume of an indoor area to at least an acceptable predetermined concentration level, the method comprising:
receiving an airflow of radon-entrained indoor-air from an indoor area via an inlet of an enclosure, wherein the enclosure includes an adsorbent medium configured to capture only a fraction of radon entrained in an airflow flowing over and/or through the adsorbent medium;
flowing the airflow of radon-entrained indoor-air over and/or through the adsorbent medium at an airflow volume rate over a period of time; and
capturing, by the adsorbent medium, only between about 0.1 to 10 percent of the concentration of radon contained in the airflow of radon-entrained indoor-air entering the enclosure,
wherein the concentration of radon in the total indoor-air volume of the indoor area is reduced to at least an acceptable, predetermined concentration after the period of time.

35. The method of claim 34, wherein the acceptable, predetermined concentration of radon in the total volume of indoor-air is maintained via a continual airflow of radon-entrained indoor-air through the adsorbent medium.
